(19) United States
(12) Patent Application Publication
(10) Pub. No.: US 2022/0237200 A1
(43) Pub. Date: Jul. 28, 2022

(54) KPRISM: DATA ANALYTICS SOLUTION FOR CONTINUOUS MONITORING SOLUTIONS AND REPETITIVE DATA DRIVEN TASKS

(71) Applicant: KPMG Assurance and Consulting Services LLP, 400011 (IN)

(72) Inventors: KG PURUSHOTHAMAN, Mumbai (IN); Bharat CHADHA, Noida (IN); Aayushi ANAND, Gurugram (IN); Meena MITTAL, Noida (IN); Gesu SHRIVASTAVA, Gurugram (IN)

(73) Assignee: KPMG Assurance and Consulting Services LLP, 400011 (IN)

(21) Appl. No.: 17/158,529

(22) Filed: Jan. 26, 2021

(51) Int. Cl. G06F 16/25

(52) U.S. Cl. CPC G06F 16/252

(57) ABSTRACT

The present invention discloses a system and method providing a cloud-based data analytics solution for automation of continuous monitoring solutions and repetitive data driven tasks. The tool can be used by client to perform analysis on large volumes of data through its pre-configured library standardised routines created using SAP base tables. The system provides for selection of a standard library from a set of libraries and uploading of data using web or Secure File Transfer Protocol (SFTP). Further, standard KPIs are created, edited and executed considering the selected library. Finally, an output comprising analysis to the user on a dashboard is presented to a user.

### TECHNICAL FIELD OF THE DISCLOSURE

The present invention relates to a cloud-based data analytics solution for automation of continuous monitoring solutions and repetitive data driven tasks. The tool can be used by one or more clients to perform data analysis on a number of records through its pre-configured library of over 450 standardised routines created using SAP base tables.

### BACKGROUND

As global organisations aim to address the rapidly evolving and often complex risk environment and meet ever-changing regulatory, business, and industry requirements, most internal audit departments are faced with an impossible task of identifying, assessing and monitoring risks which they must do so with smaller budgets and fewer people. Internal audit departments are forced to adapt to rapid change in organisation structure, business processes, and frequently to do so with a global footprint. Many have begun to advance their efforts by implementing continuous auditing (CA) and continuous monitoring (CM) disciplines around their organisational processes, transactions, systems, and controls.

A US application US20190132350A1 describes a system that provides data validation and risk management for distributed storage systems such as blockchain. It facilitates a user to specify the risks they wish to manage through a user interface and based on their selection, provides a real-time monitoring and analysis. The risk framework can include categories like governance and oversight of the blockchain, cybersecurity issues with the blockchain, infrastructure risks, blockchain architecture risks, operational risks, and transactional risks.

Further US20150301698A1 provides a method for analyzing information technology resources of an organisation. It provides a user interface that allows a user to select classification parameters relating to the features of the assets to be analysed. The invention generally describes about improving the efficiency with which information technology assets and/or resources are analyzed and/or deployed in an organisation. US20150301698A1 also discloses about selection of one or more KPIs from a menu/list to obtain insightful information.

Further, US20190147363A1 application is directed towards monitoring performance of a system at a service level using key performance indicators (CPU usage, memory usage) derived from machine data and provide users with insight to the performance of monitored services, such as, services pertaining to an information technology (IT) environment.

Further, a non-patent literature “SAP Solutions” discloses about a cloud-based data analysis system namely SuccessFactors which can be linked with SAP or ERP systems of an organization, which is an essential novelty part of the invention. The disclosed system also provides a list of more than 2000 KPIs to choose from the user interface to run an analysis for service.

Further U.S. Ser. No. 10/459,951B2 discloses a method determining automated sequences for resolution of a ticket. The method describes formation of ticket clusters based on information provided about the ticket, user actions and time at which the ticket is logged by the user. An automation system then determines automation sequences for resolution of the ticket.

However, implementation of continuous auditing (CA) and continuous monitoring (CM) involves enormous amounts of data that needs to be processed and analysed in order to deliver regular insight into the status of controls and transactions across the global enterprise, enhancing risk and control oversight capability through monitoring and detection. Leveraging proactive, technology-based applications handling huge chunks of data to manage performance and key areas of risk and control has become a practical and necessary alternative to meet the growing needs of the organisation. Thus, there arises a need for implementing data analytics based solutions in order to effectively combine data, tools, people and processes to derive value from the unstructured/raw data.

There is no solution providing for features such as receiving data in unstructured format (scanned or pdf documents) and converts it into an analyzable format along with disclosing unique functionality of the repository of standard libraries wherein selection can be made to specify KPIs and analyse data accordingly on a cloud based platform.

### SUMMARY

One or more shortcomings of prior art are overcome, and additional advantages are provided through present disclosure. Additional features are realized through techniques of the present disclosure. Other embodiments and aspects of the disclosure are described in detail herein and are considered a part of the present disclosure.

In one aspect of the disclosure, a method for providing a data analytics solution in a system. A user selects a standard library from a set of libraries. The library is a ready to deploy repository of key risk indicators (KRIs)/key performance indicators (KPIs) across multiple business functions across industries. Further data to be analysed is uploaded using web or Secure File Transfer Protocol (SFTP). The data is in unstructured format and is converted into an analyzable format. The data is integrated from multiple sources into a data warehouse. The data is appended to existing templates and is mapped and executed to standard tables. In next step standard KPIs pertaining to the library are created, edited and executed. Segregation of the standard KPI is performed based on a sub processes selected by the user. The user then selects a dashboard and a connect is established with the dashboard and an output comprising analysis is presented to the user on the dashboard.

In another aspect of the disclosure, a system for providing a data analytics solution is disclosed, wherein the system comprises an interaction unit receiving an input from a user wherein the user selects a standard library from a set of libraries. A transfer unit uploads data using web or Secure File Transfer Protocol (SFTP) wherein the data is appended to existing templates and is mapped and executed to standard tables. The data is in unstructured format and is converted into an analyzable format. The data is integrated from multiple sources into a data warehouse. Further, a processing unit creates, edits and executes standard KPIs based on a rule engine pertaining to the library selected wherein segregation of the standard KPI is performed based on a sub processes selected by the user. Further, a presentation unit presents an output comprising analysis to the user on a dashboard wherein the dashboard is selected based on a user input.

Foregoing summary is illustrative only and is not intended to be in any way limiting. In addition to illustrative aspects, embodiments, and features described above, further aspects, embodiments, and features will become apparent by reference to drawings and following detailed description.

### BRIEF DESCRIPTION OF DRAWINGS

FIG. 1 is a diagram representing a system for data analysis.

FIG. 2 is a diagram representing a system describing flow for data analysis.

FIG. 3 is a diagram representing a method for data analysis.

### DETAILED DESCRIPTION

In following detailed description of embodiments of present disclosure, numerous specific details are set forth in order to provide a thorough understanding of the embodiments of the disclosure. However, it will be obvious to one skilled in art that the embodiments of the disclosure may be practiced without these specific details. In other instances, well known methods, procedures, components, and circuits have not been described in detail so as not to unnecessarily obscure aspects of the embodiments of the disclosure.

References in the present disclosure to “one embodiment” or “an embodiment” mean that a feature, structure, characteristic, or function described in connection with the embodiment is included in at least one embodiment of the disclosure. Appearances of phrase “in one embodiment” in various places in the present disclosure are not necessarily all referring to same embodiment.

In the present disclosure, word “exemplary” is used herein to mean “serving as an example, instance, or illustration.” Any embodiment or implementation of present subject matter described herein as “exemplary” is not necessarily to be construed as preferred or advantageous over other embodiments.

The present disclosure may take form of a hardware embodiment, a software embodiment, or an embodiment combining software and hardware aspects that may all generally be referred to herein as a ‘system’ or a ‘module’. Further, the present disclosure may take form of a computer program product embodied in a storage device having computer readable program code embodied in a medium.

While the disclosure is susceptible to various modifications and alternative forms, specific embodiment thereof has been shown by way of example in drawings and will be described in detail below. It should be understood, however that it is not intended to limit the disclosure to the forms disclosed, but on contrary, the disclosure is to cover all modifications, equivalents, and alternative falling within scope of the disclosure.

Terms such as “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude existence of other elements or additional elements in the system or apparatus.

In following detailed description of the embodiments of the disclosure, reference is made to drawings that form a part hereof, and in which are shown by way of illustration specific embodiments in which the disclosure may be practiced. These embodiments are described in enough detail to enable those skilled in the art to practice the disclosure, and it is to be understood that other embodiments may be utilized and that changes may be made without departing from the scope of the present disclosure. The following description is, therefore, not to be taken in a limiting sense.

In recent era, data volumes have increased significantly. With increase in volumes, variation in type and format of the data is remarkable. The present disclosure relates to a cloud based data analytics solution and more particularly to a cloud based data analytics solution for automation of continuous monitoring solutions and repetitive data driven tasks.

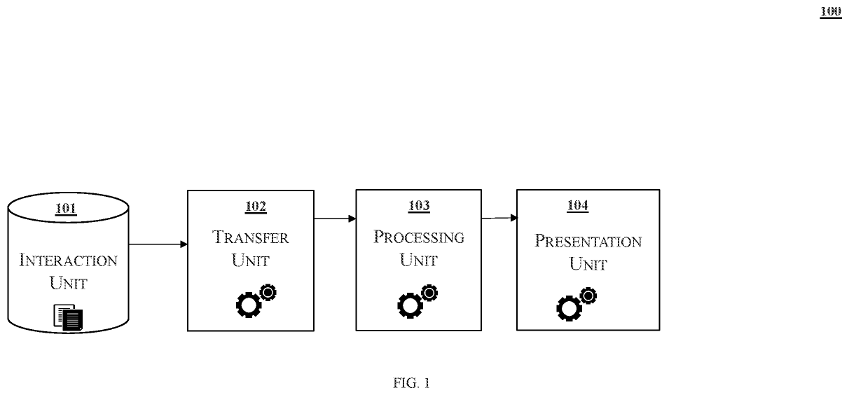

FIG. 1 explains a system 100 for analyzing data. An interaction unit 101 lets a user to interact with the system to select one or more libraries. A transfer unit 102 further uploads data using web or Secure File Transfer Protocol (SFTP) wherein the data is appended to existing templates and is mapped and executed to standard tables. A processing unit 103 then creates, edits and executes standard KPIs based on a rule engine pertaining to the library selected wherein segregation of the standard KPI is performed based on a sub processes selected by the user. A presentation unit 104 then presents an output comprising analysis to the user on a dashboard wherein the dashboard is selected based on a user input. The data can be in structured or un-structured format and can be fed from multiple sources. The data is converted into an analyzable format. The data from multiple sources is integrated into a data warehouse. The library mentioned above is a ready to deploy repository including key risk indicators (KRIs)/key performance indicators (KPIs) across multiple business functions across industries.

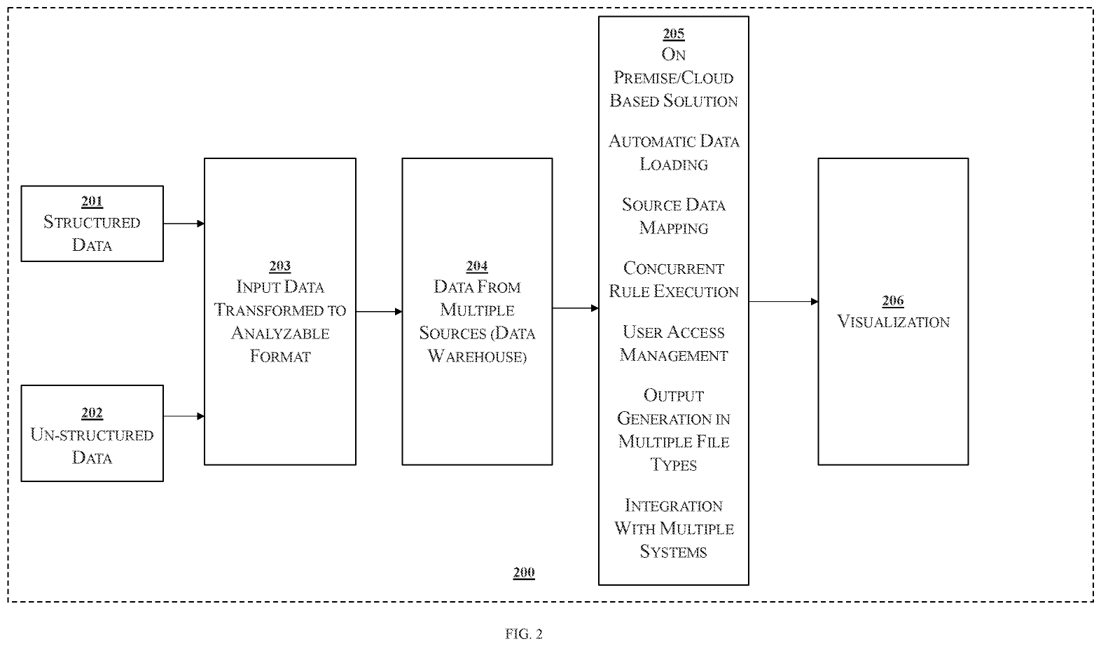

In an embodiment FIG. 2 explains a system 200 determining a flow of analysis of data. At 203 data from structured sources 201 and un-structured sources 202 is converted to an analyzable format. Further, data from multiple sources is integrated at a data warehouse 204. The data is then moved onto a cloud based or on-premise solution 205 for analysis. The solution offers multiple capabilities such as automatic loading of data, source data mapping, concurrent rule-based execution, user access management, output generation in multiple file types and integration with other systems. Once the data is analyzed, analysis is moved to visualization 206 for presenting to a user.

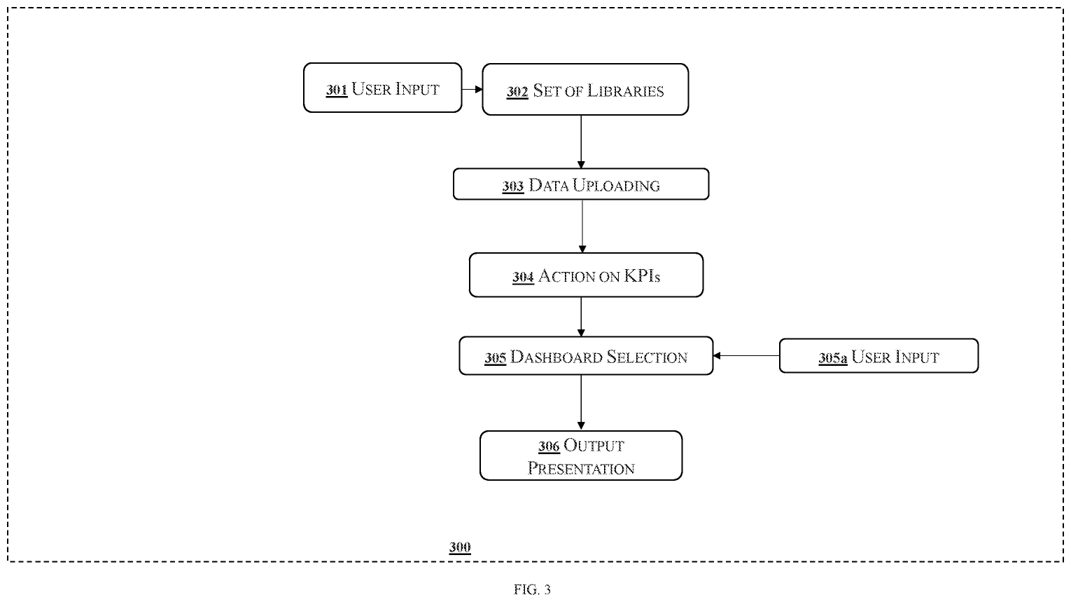

FIG. 3 explains a detailed method 300 of analyzing of data. At step 301, a user input is provided to select one or more libraries from a set of libraries 302. At step 303 uploading of data is performed from one or more sources. The sources provide data in multiple formats and types. At this step the data is converted into an analyzable format and integrated into a single warehouse. At step 304, action is taken on KPIs. KPI to be executed is selected and relevant tables are then imported. The imported tables are then mapped to standard tables the KPI is executed. At step 305, dashboard for presentation of analysis is selected by a user input 305a. The analysis is then presented at step 306.

The system 100 has a three-tier architecture with multiple hosting options such as on-premise or cloud. It can be integrated with big data framework as well as visualization tools and requires one-time deployment with annual maintenance contract (AMC) managed services. The system consists of standard process-wise libraries containing different kinds of KPIs.
HR/Payroll library: The said library contains 15+ KPIs and consists of the following kinds of data such as comparison of learning opportunities provider (LOP) data as per attendance versus payroll systems, duplicate payments made to the employees reimbursements and reconciliation of leaves taken versus leave balance; attendance versus earnings; leaves taken versus attendance.
Procure to Pay Library (P2P): The said library contains 175+ KPIs and consists of the following kinds of data such as aged purchase order (PO) analysis, duplicate analysis of multiple PO/purchase request (PR)/invoices/payments, trend analysis—invoices and blocked vendor analysis.
Inventory Library: The said library contains 100+ KPIs and consists of the following kinds of data such as anomalies in the current inventory stock, inventory summary, material master and movements and material movements/goods received on weekends or holidays.
Financial accounting (FI)—Accounts Payable (AP)/Accounts Received (AR)/General Ledger (GL) Library: The said library contains 80+ KPIs and consists of the following kinds of data such as AR aging by due date/invoice date (AR), customers transaction summary (AR), invoice and payments processed by same user id (AP) and identify changes made to GL master by unauthorised persons.
Fixed assets library: The said library contains 10+ KPIs and consists of the following kinds of data such as identify cases where assets useful life not proportionate to the depreciation key (defined in Master) and assets under construction are capitalized appropriately or not.
Order to Cash (O2C) library: The said library contains 50+ KPIs and consists of the following kinds of data such as sales order conflicts for invoice creation, sales order creation and user authorisation, high ageing of open sales order, duplicate invoices based on same invoice no, value & customer and value of sales order for a customer is greater than the respective credit limit.

The users select the standard library that they wish to seek the analysis for such as Procure to pay, Order to cash, inventory, finance and human resource. Once the user selects the standard library, the data is uploaded through using web or Secure File Transfer Protocol (SFTP). The data is further appended to existing templates and is mapped and executed to standard tables. Further, once the data is uploaded, the rule engine creates/edits/runs standard KPIs pertaining to the library selected by the user. Standard KPI segregation is performed based on sub processes selected by the user and the output is analysed. The KPI output is linked to interactive dashboards.

In the present implementation, the system (100) includes one or more processors. The processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory. The system further includes I/O interfaces, memory and modules.

The I/O interfaces may include a variety of software and hardware interfaces, for example, a web interface, a graphical user interface, and the like. The I/O interface may allow the system to interact with a user directly or through user devices. Further, the I/O interface may enable the system (100) to communicate with other user devices or computing devices, such as web servers. The I/O interface can facilitate multiple communications within a wide variety of networks and protocol types, including wired networks, for example, LAN, cable, etc., and wireless networks, such as WLAN, cellular, or satellite. The I/O interface may include one or more ports for connecting number of devices to one another or to another server.

The memory may be coupled to the processor. The memory can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the system (100) includes modules. The modules include routines, programs, objects, components, data structures, etc., which perform tasks or implement particular abstract data types. In one implementation, module includes a display module and other modules. The other modules may include programs or coded instructions that supplement applications and functions of the system (100).

As described above, the modules, amongst other things, include routines, programs, objects, components, and data structures, which perform particular tasks or implement particular abstract data types. The modules may also be implemented as, signal processor(s), state machine(s), logic circuitries, and/or any other device or component that manipulate signals based on operational instructions. Further, the modules can be implemented by one or more hardware components, by computer-readable instructions executed by a processing unit, or by a combination thereof.

Furthermore, one or more computer-readable storage media may be utilized in implementing some of the embodiments consistent with the present disclosure. A computer-readable storage medium refers to any type of physical memory on which information or data readable by a processor may be stored. Thus, the computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

1. A method for providing a data analytics solution in a system, the method comprising:
a user selecting a standard library from a set of libraries;
uploading data using web or Secure File Transfer Protocol (SFTP) wherein the data is appended to existing templates and is mapped and executed to standard tables;
creating, editing and executing standard KPIs pertaining to the library selected wherein segregation of the standard KPI is performed based on a sub processes selected by the user;
selecting a dashboard and establishing a connect with the dashboard; and
presenting an output comprising analysis to the user on the dashboard.

2. The method as claimed in claim 1, wherein the data is in unstructured format and is converted into an analyzable format.

3. The method as claimed in claim 1, wherein the data is integrated from multiple sources into a data warehouse.

4. The method as claimed in claim 1, wherein the Library is a ready to deploy repository of key risk indicators (KRIs)/key performance indicators (KPIs) across multiple business functions across industries.

5. A system for providing a data analytics solution, the system comprising:
an interaction unit receiving an input from a user wherein the user selects a standard library from a set of libraries,
a transfer unit uploading data using web or Secure File Transfer Protocol (SFTP) wherein the data is appended to existing templates and is mapped and executed to standard tables,
a processing unit creating, editing and executing standard KPIs based on a rule engine pertaining to the library selected wherein segregation of the standard KPI is performed based on a sub processes selected by the user, and
a presentation unit presenting an output comprising analysis to the user on a dashboard wherein the dashboard is selected based on a user input.

6. The system as claimed in claim 5, wherein the data is in unstructured format and is converted into an analyzable format.

7. The system as claimed in claim 5, wherein the data is integrated from multiple sources into a data warehouse.

8. The system as claimed in claim 5, wherein the library is a ready to deploy repository of key risk indicators (KRIs)/key performance indicators (KPIs) across multiple business functions across industries.

9. The system as claimed in claim 5, wherein the system is hosted on a distributed network.
